(19) United States
(12) Patent Application Publication
(10) Pub. No.: US 2002/0088152 A1
(43) Pub. Date: Jul. 11, 2002

(54) Method and device for determining mattress rotation

(76) Inventor: Margaret Esterman, Alexander, NC (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/756,116

(22) Filed: Jan. 9, 2001

(51) Int. Cl. G09F 3/10

(52) U.S. Cl. 40/299.01

(57) ABSTRACT

A method for determining mattress rotation sequence and time by tracking the position of indicia on the top and bottom sides of a mattress with the aid of a graphically imprinted device. A block or board is imprinted with icons representing four possible mattress positions and the twelve calender months of the year. One pair of icons represents the top and bottom sides of the mattress, another pair of icons represents the head and the foot ends of the mattress. Each month and mattress position has a corresponding hole for receiving a peg. A first label is affixed to the foot-end of the top side of the mattress and a second label of a different color or configuration is affixed to the foot-end of the bottom side of the mattress. The consumer places the peg in the icon hole corresponding to the position of the labels on the mattress, and places a peg in the hole corresponding to the month of the year. The mattress is turned from side to side or end to end, according to the sequence of icons.

Alternatively, the reminder device is electronic and each month and mattress position has a corresponding electronically generated cue. The cue may be visual such as a light, tactile such as a raised bump or auditory such as an alarm.

In another embodiment the reminder device has two rotatable disks. One disk is imprinted with the time orientation icons and the second disk is imprinted with the four possible mattress orientation icons. The mattress is turned according to the sequence of icons on the disks.

### BACKGROUND

It is well known that rotating a mattress on a periodic basis will extend the life and improve the comfort of the mattress. Rotation of a mattress distributes the wear among the surfaces and allows air to circulate among the various surfaces. Mattresses and futons develop wear patterns based on frequency of use and the weight of the user. While there is quite a bit of difference as to what various manufacturers actually recommend, it is a desirable to rotate a sleep system often to promote even wear; to allow air to circulate among the various surfaces; and, to reduce the inevitable wear patterns that develop on all mattresses. The only mattresses that don't require rotation are the air supported sleep systems such as those marketed under the name “Comforter.” Such products are made softer or firmer through air support which eliminates the wear pattern problem. How long a sleep set lasts depends on its original quality and how it is used. The performance of a poor quality set can deteriorate quickly while top quality sets can be expected to perform well for many years. Regardless of the quality of the sleep system, the life of the system can be extended and sleep quality enhanced with regular rotation. A set should generally last for about ten years of nightly use if properly rotated; and, back injury due to sleeping on unevenly worn mattresses can thereby be avoided.

U.S. Pat. No. 4,095,299 discloses a label and method for determining mattress rotation. A first label is affixed to the upper surface of the mattress and a second label is affixed to the lower surface of the mattress. The labels provide instruction for the mattress to be turned over. There is no reminder system, such as a monthly date, to remind one when to turn the mattress, only a label to indicate mattress orientation.

There are also numerous mattress turning devices which assist one in physically turning a mattress. Mandelbaum (U.S. Pat. No. 2,445,030) describes a mattress turning device that physically facilitates the reversal of a mattress. The reference does not mention any reminder label or device associated with the turning device to remind a person of a particular time or orientation in which the mattress is to be turned. There are also mattresses with indicia on the ends, such as Muzaurieta (U.S. Pat. No. 3,376,585) which depicts a mattress having indica on the end of the mattress; however, the indicia relates to instructions for turning on and off a musical device contained within the mattress.

### SUMMARY

The invention relates to a method and device for indicating when and in which direction a mattress should be turned in order to extend the life of the mattress. The invention is also applicable to futons and other sleeping systems.

It is often difficult to remember the time of the last mattress rotation and the direction in which the mattress was flipped. A different turning motion is needed from month to month in order to cycle the mattress evenly through the four mattress positions. In some months a lateral turn from head to foot is necessary and in other months a flip over turn from topside to bottom side is necessary. The method and device of the present invention easily solves this problem with a simple and inexpensive reminder device that can be kept at a bedside.

A block or board is imprinted with icons representing four possible mattress positions and the twelve calendar months of the year. One pair of icons represents the top and bottom sides of the mattress , another pair of icons represents the head and the foot ends of the mattress. Each month and mattress position has a corresponding hole for receiving a peg. A first label is affixed to the foot-end of the top side of the mattress and a second label of a different color or configuration is affixed to the foot-end of the bottom side of the mattress. The consumer places the peg in the icon hole corresponding to the position of the labels on the mattress, and places a peg in the hole corresponding to the month of the year. The mattress is thus turned from side to side or end to end, according to the sequence of icons. Alternatively, in place of a mechanically movable marker the device can have an electronic display signal to indicate the mattress orientation and time frame. In another electronic embodiment only the mattress orientation icons are graphically displayed. A signal alerts the user that it is time to rotate the mattress and the display device displays the next mattress orientation. The electronic signal can be an auditory alarm, a tactile alarm or a visual display such as a blinking light.

The device can be used in an institutional environment such as a hospital or hotel where many employees are responsible for the task of turning mattresses. Use of the device in an institutional setting can considerably extend the wear and comfort of multiple mattresses resulting in significant savings.

### BRIEF DESCRIPTION OF THE DRAWINGS

Various other features and attendant advantages of the present invention will be more fully appreciated as the same become better understood when considered in conjunction with the accompanying drawings, in which like reference characters designate the same or similar parts throughout the several views, and wherein:

FIG. 1 is an perspective view of a preferred embodiment of the present invention showing the orientation icons and the month of the year icons.

FIG. 2 is a view of mattress indicia

2a view

2b view

FIG. 3 is a view of a preferred embodiment of the present invention showing the orientation icons on a first rotatable disk and the time related icons on a second rotatable disk.

FIG. 4 is a view of another preferred embodiment showing an electronic reminder device.

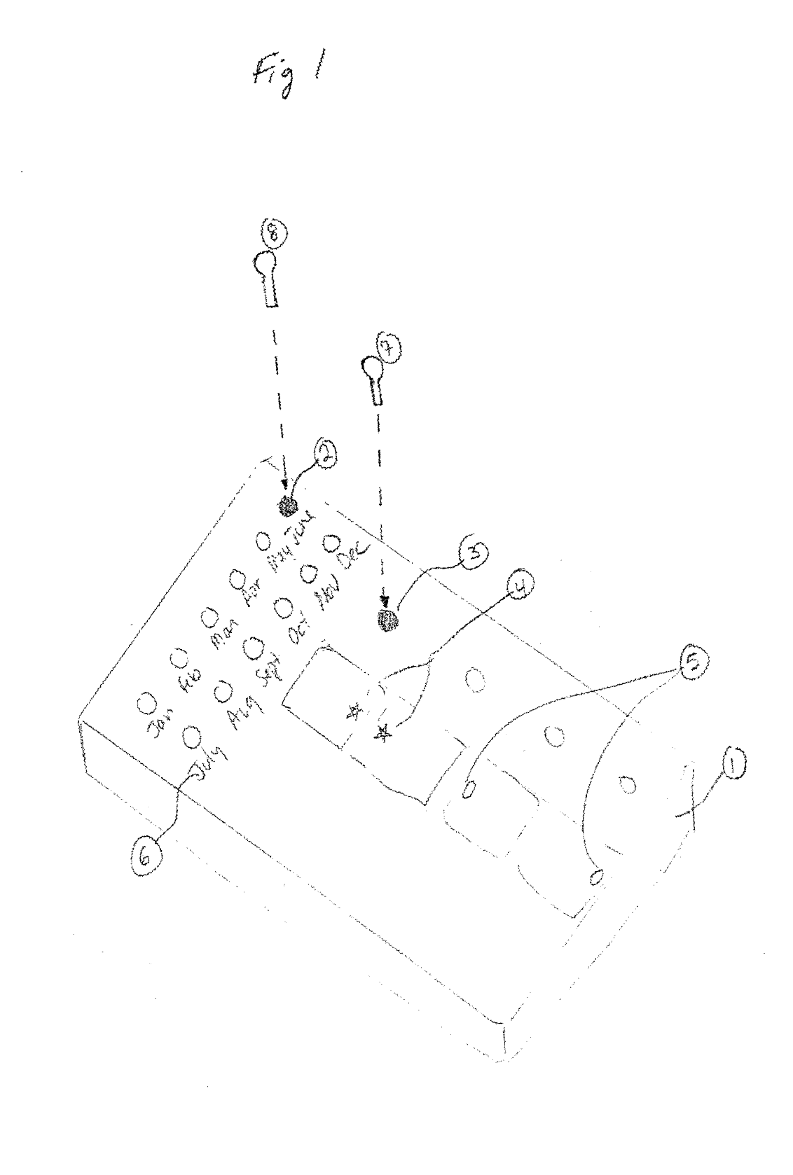

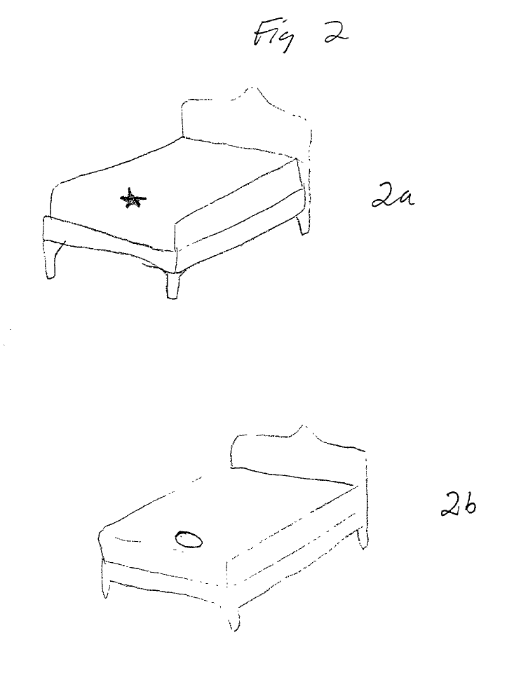

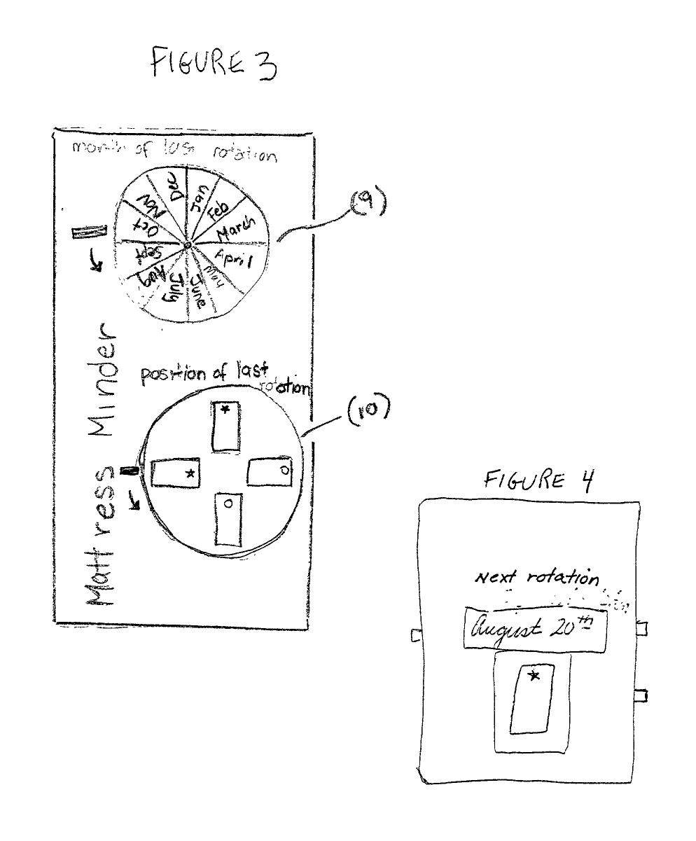

### DESCRIPTION OF PREFERRED EMBODIMENTS

A block or board (1) is imprinted with icons representing four possible mattress positions (4)(5) and the calendar months of the year (6). It is recommended that mattresses be turned every month to extend the life and comfort of the mattress. The device of the present invention helps keep track of the month of the last mattress rotation. Once the mattress is turned, the new position is noted by inserting a peg (7) next to the corresponding mattress orientation icon on the device. The second peg (8) is inserted into the hole next to the current month on the device. In the following months the mattress is turned to match the label positions on the device with the label position on the mattress. The icons are followed from top to bottom to insure that all the mattress positions are used sequentially and the wear on the mattress is equally distributed.

In a preferred embodiment the twelve calendar months are represented, however, any indicia that will provide a time reference which prompts a person to rotate the mattress, such as the seasons or holidays, can be used. One pair of icons represents the top and bottom sides of the mattress (4), another pair of icons represents the head and the foot ends of the mattress (5). In a preferred embodiment each month and mattress position has a corresponding hole for receiving a peg (2) (3), however other marker systems, such as magnets or lights can be used to mark the selected icon.

A first label is affixed to the foot-end of the top side of the mattress and a second label of a different color, icon or configuration is affixed to the foot-end of the bottom side of the mattress. In a preferred embodiment the labels are color coded to match the color coded mattress orientation icons on the block or board. Any means to mark the mattress ends can be used as long as they correlate to the icons on the device.

The consumer places the peg (7) in the icon hole corresponding to the position of the labels on the mattress (3), and places a peg in the hole corresponding to the month of the year (2). The mattress is then turned from side to side or end to end, according to the sequence of icons.

In another preferred embodiment the months of the year are imprinted on a rotatable disk (9) which the user turns to indicate either the month the mattress was last turned or the month of the next rotation. A second disk (10) is imprinted with the four possible mattress orientations. The user turns the disk to keep track of the last mattress position or to indicate the next mattress position.

In another preferred embodiment the reminder device is electronic. The electronic embodiment displays the date of last rotation or the date of the next rotation. Alternatively, no date at all is displayed and the device generates an automatic signal at a preset time to prompt the user to turn the mattress. Thus, an alarm type function is preset. Turning off the signal resets the device to the next time and orientation sequence. The preset signal can be visual such as a blinking light, auditory such as a beep or tactile such as a raised bump or flag. Any signal to prompt the user to turn the mattress is suitable. The electronic embodiments display the selected mattress orientation icon of the last rotation or of the next rotation. The mattress orientation icons correspond to the labels that mark the mattress ends.

From the foregoing description, one skilled in the art can easily ascertain the essential characteristics of this invention and, without departing from the spirit and scope thereof, can make various changes and modifications of the invention to adapt it to various usages and conditions.

We claim:

1. A mattress rotation reminder device comprising:
a display board having,
a plurality of mattress orientation icons,
at least two icons related to time, and,
a marker for selecting a mattress orientation icon and an icon related to time; and,
indicia for placement on the mattress to indicate orientation.

2. A mattress rotation reminder device according to claim 1, wherein the time icons are the calendar months of the year.

3. A mattress rotation reminder device according to claim 1, wherein the time icons are the seasons of the year.

4. A mattress rotation reminder device according to claim 1, wherein the marker comprises a peg for insertion into a hole next to each icon.

5. A mattress rotation reminder device according to claim 1, wherein the display board is magnetic.

6. A mattress rotation reminder device according to claim 1, wherein the marker is magnetic.

7. A mattress rotation reminder device according to claim 1, wherein the display board is electronic.

8. A mattress rotation reminder device according to claim 1, wherein the marker is an electronic visual cue.

9. A mattress rotation reminder device according to claim 1, wherein the marker is a tactile cue.

10. A mattress rotation reminder device according to claim 1, wherein the icons are graphic images.

11. A mattress rotation reminder device according to claim 1, further comprising an auditory signal.

12. An electronic mattress rotation reminder device comprising:
a mattress orientation icon display,
a signal related to time which prompts the user to rotate a mattress according to the mattress orientation icon, and,
indicia for placement on the mattress to indicate orientation.

13. An electronic mattress rotation reminder device according to claim 12, wherein said signal related to time is a visual cue.

14. An electronic mattress rotation reminder device according to claim 12, wherein said signal related to time is an auditory cue.

15. An electronic mattress rotation reminder device according to claim 12, wherein said signal related to time is a tactile cue.

16. A method to remind a user when and in which direction to rotate a mattress comprising;
a) placing a first marker on a display device so said marker corresponds to a mattress orientation icon,
b) placing a second marker on said display device so said marker corresponds to a time related icon,
c) rotating the mattress according to the sequence of icons on the display device and
d) moving the first and second markers to record the rotation time and orientation.

17. A method to remind a user when and in which direction to rotate a mattress comprising;
a) turning a disk on a display device to select a mattress orientation icon,
b) turning a second disk on said display device to select a time related icon, and
c) rotating the mattress according to the sequence of icons on the display device.
